(19) United States
(12) Patent Application Publication
(10) Pub. No.: US 2011/0173346 A1
(43) Pub. Date: Jul. 14, 2011

(54) ADAPTIVE METHOD AND DEVICE FOR CONVERTING MESSAGES BETWEEN DIFFERENT DATA FORMATS

(75) Inventor: Uwe Neben, Rosdorf (DE)

(73) Assignee: CROSSGATE AG, Muenchen (DE)

(21) Appl. No.: 13/058,597

(22) PCT Filed: Aug. 13, 2009
(86) PCT No.: PCT/EP09/05880

§ 371 Date: Mar. 29, 2011

(30) Foreign Application Priority Data
Aug. 14, 2008 (EP) EP08014531

(51) Int. Cl. G06F 15/16

(52) U.S. Cl. 709/246

(57) ABSTRACT

A computer-implemented method for converting messages between different data formats in a network for electronic data interchange (EDI), comprises: receiving (110) an electronic message from a participant of the network; determining (120) at least one first possible data format of the electronic message, based on the content of the electronic message; validating (130) the electronic message, based on the at least one first possible data format; and converting (140) the message from the first data format into a second predetermined data format, using a message mapping definition associated with the first data format, if the validating step succeeds; and learning a new data format that validates the electronic message and an associated message mapping definition otherwise.

The present invention relates to the field of Electronic Data Interchange (EDI). More particularly, it relates to a computer-implemented method and a device for automatically converting messages between different data formats. The present invention also relates to a computer-implemented tool for generating new routines or modules automatically, given a sample message and a database of given modules for automatically converting messages between different data formats.

### TECHNICAL BACKGROUND AND STATE OF THE ART

Electronic Data Interchange (EDI) may be defined as the computer-to-computer interchange of strictly formatted messages that represent documents. EDI implies a sequence of messages between two parties, either of whom may serve as originator or recipient. The formatted data representing the documents may be transmitted from originator to recipient by telecommunications or physically transported on electronic storage media.

In EDI, the usual processing of received messages is by computer only. Human intervention in the processing of a received message is typically intended only for error conditions, for quality review and for special situations. For example, the transmission of binary or textual data is not EDI according to this definition, unless the data are treated as one or more data elements of an EDI message and are not normally intended for human interpretation as part of online data processing (Kantor, M. et al., Apr. 29, 1996, Electronic Data Interchange EDI, National Institute of Standards and Technology).

In order to be interpretable by the receiver, message data formats must conform to a known structure. Nowadays, a large number of different formats exist for EDI messages, e.g. SWIFT (for banks), UN/EDIFACT, ANSI ASC X12, GTDI, VDA, ODETTE, Fortras, etc, for different application fields and branches. Generally, a data format is characterized by a message's syntax and its semantics, wherein the syntax defines the structure of the message in terms of message components or data elements and their ordering and the semantics define the interpretation or meaning of the message components/data elements.

Due to the multitude of alternative data formats, it is very likely that two participants planning to interchange electronic data will use different formats for their messages. Consequently, messages must be converted from the sender's data format to the receiver's data format, such that the receiving system is able to interpret and process the message correctly. This can only be achieved by knowing the semantics, or the meaning of individual data elements, for example when mapping to a particular target format. This complexity is aggravated due to the multitude of potential or actual participants in an electronic data interchange system. Consequently, reducing the amount of human intervention in the construction of systems for electronic data interchange and providing efficient mechanisms for their operation is an important condition for their functioning.

According to the state of the art, modules for automatically converting messages or data between different formats have been built by hand, by a skilled person knowing both the data format of the sender and the data format of the receiver, e.g. a programmer. These message mapping modules or schemes, also called converters, have a fixed association with a particular sender/receiver and convert a message from one format to another, thereby changing its syntax, its semantics and also the content possibly.

When associated with a particular sender or receiver, the message mapping modules or converters may also be called participant or partner modules. In other words, message mapping systems according to the state of the art invoke a matching message conversion scheme based on the identity of the sender/receiver and the message format that is associated with them. As every sender and every receiver may use a different format for the same messages or data, potentially a large number of modules for automatically converting messages between different formats must be created and pre-installed.

In the prior art, two approaches have been made in order to alleviate this complexity. First, intermediate formats have emerged, to which original input message or data formats are mapped first and from which the necessary output message or data formats are generated. Creating such a meta- or ‘hub’-format obviates the need of having modules for converting between formats for each pair of participants in a system for electronic data interchange and reduces the associated complexity at least in part.

Second, libraries/repositories of already existing modules for automatically converting data or messages between different formats are used. Such a module library/repository or database, called ‘business process repository’ (BPR) in the context of the present application, may often further reduce the task of creating a new module to selecting a most suitable or similar module from the library/repository and adapting it to a new message format.

However, in both cases, manual work for creating new modules or for searching, selecting and adapting existing modules, and for assigning them to participants of the network, remains an important cost factor and a major obstacle for the adoption and the spread of systems for electronic data interchange.

It is therefore an object of the present invention to provide a method and a system for automatically converting messages or data between different formats that reduces the necessary amount of human intervention in creating mappings between different formats. The method must also be adaptive in order to accommodate changing message format standards.

Finally, it is a further object of the invention, to provide a tool for an electronic data interchange systems user or configurator that allows him to identify and select modules for automatically converting messages between different message or data formats existing in a module library, for adaptation to new message formats.

### BRIEF SUMMARY OF THE INVENTION

According to the invention, these objects are achieved by a method and a system according to the independent claims. Advantageous embodiments are defined in the dependent claims.

According to an aspect of the invention, a computer-implemented method for converting messages between different data formats in a network for electronic data interchange (EDI), may comprise the steps of receiving (110) an electronic message from a participant of the network; determining (120) at least one first possible data format of the electronic message, based on the content of the electronic message; validating (130) the electronic message, based on the at least one first possible data format; converting (140) the message from the first data format into a second predetermined data format, using a message mapping definition associated with the first data format, if the validating step succeeds; and learning a new data format that validates the electronic message, and an associated message mapping definition, otherwise. The new data format may be learned automatically, or at least with only little human intervention. Thereby, new participants may be integrated into the electronic data interchange system without manual intervention of a system administrator, associating a particular participant with a particular data format manually.

According to a second aspect of the invention, the method may determine a plurality of first possible data formats of the electronic message, e.g. based on a likelihood, that the message complies with a given data format. The fact that a plurality of first possible data formats is automatically determined, instead of one, may be compensated by validating each of the entire determined set of possible data formats, resulting again in one single data format, if validation succeeds.

According to a third aspect of the invention, the at least one possible data format may be determined from a machine-readable non-volatile memory comprising a multitude of possible data formats. By leveraging an existing database of possible data formats, the determination of possible data formats may be reduced to a search in the database. The probability of successfully determining and validating a matching data format may also be increased by simply extending the database.

According to a further aspect, the step of converting may comprise the steps of retrieving a predetermined message mapping scheme associated with the first data format; and applying the predetermined message mapping scheme to the electronic message in order to convert it into the second data format. Thereby, a time-consuming explicit search or ad-hoc synthesis of a message mapping or conversion scheme may be avoided.

According to yet another aspect of the invention, an association of the participant and the first data format may be stored in a machine-readable non-volatile memory for future reference, if the validating step succeeds. When a single data format is associated with several participants, this allows an efficient storage of data formats (‘call-by-reference’). Moreover, changes in the data format only have to be effected once and become immediately valid for all associated participants.

According to a different aspect of the invention, the step of determining may comprise the steps of checking, whether an association of the participant and an associated data format has already been stored in the machine-readable non-volatile memory; and using the associated data format as the at least one possible data format of the electronic message, if yes. By associating a participant with one or a fixed set of several data-formats, the determination of the data-format of an electronic message may take the identity of the sending participant into account, thereby reducing e.g. necessary search operations for a pertinent data format.

According to still another aspect of the invention, the step of validating may comprise the steps of automatically requesting the participant to confirm the first data format via an electronic communication channel; and validating the electronic message if the first data format is confirmed by the participant. In particular when the results of an automatic data format determination module or step may not be trusted per se or more than one data format is determined, this aspect provides the advantage of automatically leveraging a participant's input. Additionally, the electronic message may also be validated automatically, using the confirmed data format and validation rules associated with it, thereby validating the participant's confirmation in turn and hence providing an additional level of security. In a specific embodiment, a request for confirming a data format for an invoice may comprise sending an actual invoice document generated using the data format to be confirmed, e.g. as a fax or pdf document to the participant and asking whether the actual invoice document conforms to the participants intentions. Thereby, even a participant who is ignorant of the concrete data fomat may validate a determined data format, by validating the results of actually applying it.

The data format may be determined based on a proper subset of bits of the electronic message, having a predetermined size. The subset of bits may be an initial bit sequence of the electronic message. Hereby, the fact that the initial bit sequence has the highest discriminating power in EDI messages may be exploited, leading to better recognition rates. The data format may further be determined based on statistical evaluations of the electronic message, e.g. on the number of angular brackets or ‘<’ and ‘>’ signs in a message, wherein a high number indicates an XML-document or the number of colons or ‘:’ signs, indicating an EDI document. Using this additional information, cases of doubt may be resolved when the (initial) bit sequence is not decisive.

According to another aspect of the invention, the first possible data format of the electronic message may be determined using a neural network. By this, associations between contents of an electronic message and data formats may be learned automatically by a supervised learning algorithm, thereby rendering the method e.g. adaptive with respect to later additions of new data formats or changes within already existing data formats. Also, neural networks have the capability to generalize from a set of training samples, thereby reducing a complexity of the system when compared with a hard-wiring approach. Also, data format recognition does not fail due to a rigid recognition step. The fact that the neural network may determine a plurality of first possible data formats may be compensated by validating each of the entire determined set of possible data formats, resulting again in one single data format, if validation succeeds.

According to the invention, a system for converting messages between different data formats in a network for electronic data interchange (EDI), may comprise a back-end server and a front-end server, the front-end server comprising means for receiving an electronic message from a participant of the network; means for determining at least one first possible data format of the electronic message; means for validating the electronic message, based on the at least one first possible data format; and means for converting the message from the first data format into a second predetermined data format, if the validating step succeeds.

### BRIEF DESCRIPTION OF THE FIGURES

These and other aspects and advantages of the present invention will become more apparent when studying the following detailed description of an embodiment of the invention, in connection with the attached drawing in which

FIG. 1 shows a flowchart of a method for converting messages between different formats according to an embodiment of the invention.

FIG. 2 shows a flowchart of a method for determining a data format, based on the content of an electronic message.

FIG. 3a shows an excerpt of a message processed by a method according to the invention.

FIG. 3b shows an excerpt of a rule set definition that is selected based on the recognized format of the incoming message and may be used for validating the message.

FIG. 4 shows a multilayer neural network used for determining a data format of a message according to an embodiment of the invention.

FIG. 5 shows a table defining a set of mapping rules for mapping the contents of the incoming message to a different format.

FIG. 6 shows an architecture of an application system for converting messages according to an embodiment of the invention.

FIG. 7 shows a flowchart of a method for learning a new data format, applicable in the method described in FIG. 1.

### DETAILED DESCRIPTION

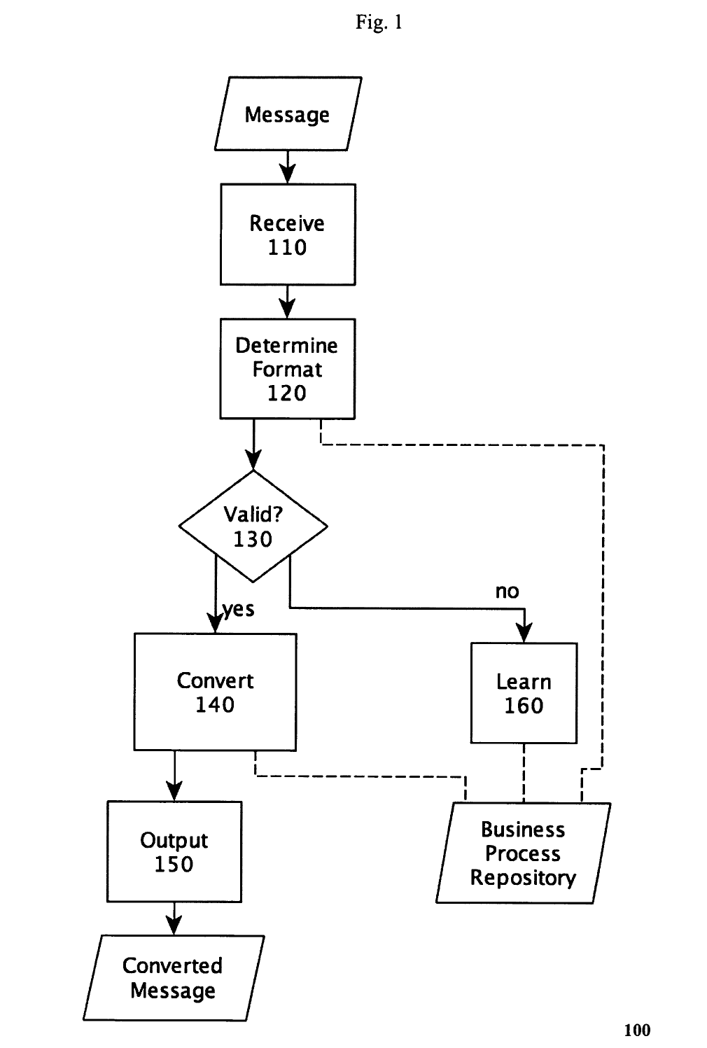

FIG. 1 shows a flowchart of a method for operating a network for electronic data interchange (EDI) according to an embodiment of the invention.

In step 110, a message having a given data format is received from a participant in a network for electronic data interchange. The data format of the electronic message may be unknown. It is assumed that the message is received in the form of a character string.

In step 120, the system tries to determine or recognize the data format of the received message, by analyzing the message. The syntactic formats may comprise the formats Edifact, VDA, ANSI X12, XML, SAP-Idoc, CSV, Flatfile having fixed or variable record length, etc. According to one embodiment of the invention, this may be achieved by matching the message against a set of syntactic data formats that are already registered in the business process repository. Preferably, the determination step determines at least one possible data format for the electronic message. However, it may also be desirable to first generate a plurality of possible first data formats for the electronic message, e.g. based on a likelihood assessment or by using an expert system.

In step 130, the method validates the message, based on the determined data format. The step of validating comprises checking whether the syntax of the message complies with the identified data format. In another embodiment, the step of validating may comprise applying a set of validation rules to the message, wherein the validation rules are associated with the determined data format.

If the validation step 130 succeeds, the method proceeds to step 140.

In the case where a plurality of possible data formats is determined, the validation step may be repeated for all members of the plurality of data formats. Assuming that the formats are disjoint, i.e. that a message always belongs to a single format, the plurality of data formats may then be reduced by validation to a single format.

According to a preferred embodiment of the invention, the step of validating the message may comprise the further steps of retrieving, from a business process repository, a message mapping module for automatically converting messages between different data formats, wherein the message mapping module is associated with the determined format. The module may comprise rules for validating the message. Validating then comprises applying these format-specific rules comprised in the module.

In step 140, the message is automatically converted or mapped from the input format to an output format associated with the determined input format. In a preferred embodiment, the format of the message is converted to an internal standard format for further processing.

In a preferred embodiment, the step of automatically converting uses the abovementioned module, which may further comprise format-specific definitions for mapping the input format to an output format.

Optionally, the automatically converted message may be written to an intermediate storage 150, before further processing.

If the validation step does not succeed, in the case of multiple formats, for any of the proposed formats, the method branches to a learning step 160.

In learning step 160, a new data format that validates the electronic message is learnt by analysing the electronic message in the context of all different syntax definitions already known in the business process repository.

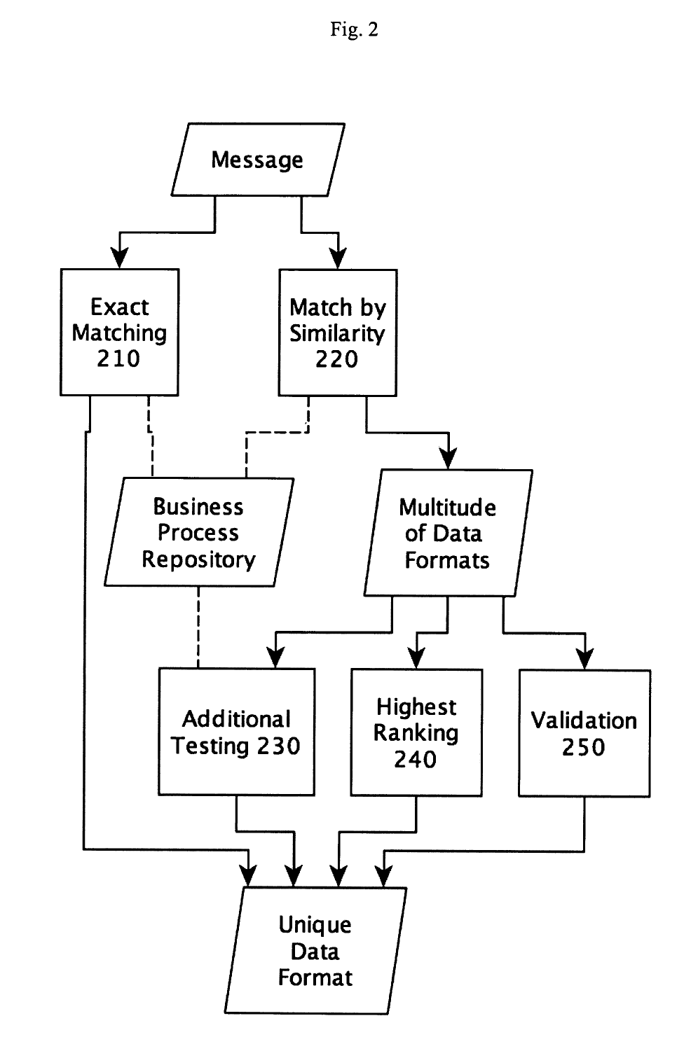

FIG. 2 shows a more detailed flowchart of how an incoming message may be matched against a set of already registered syntactic data formats according to one embodiment of the invention. This flowchart corresponds to step 120 in FIG. 1.

In an exact matching step 210, the incoming electronic message may be classified as belonging to one of a multitude of pre-determined data formats. According to one embodiment of the invention, this may be achieved by computing a hash value for the message and checking whether that hash value is already linked to a unique data format in the business processes repository. If yes, a unique data format has already been found for the incoming electronic message.

Alternatively, a multitude of possible data formats may first be determined in a similarity matching step 220. According to one embodiment of the invention, a hash value of the electronic message may also be compared to hash values already known from the business process repository. However, in contrast to step 210, the matching may be based on a similarity measure.

More particularly, similar documents may be described by similar hash values. The hash value may be constructed according to practical requirements, but is preferred to be a numerical value.

Then, in an additional testing step 230, one or several additional methods specific to the particular hash value, which has already narrowed the search to a particular subset of formats, may be applied to the incoming electronic message, in order to find a unique association to a given syntactic format.

Alternatively, in step 240, the most similar data format may be selected from the multitude, if it is unique. According to one embodiment, this may be achieved by ranking the hash values stored in the business process repository according to their similarity with the hash value computed for the electronic message.

Alternatively, in step 250, the multitude of data formats may be reduced to a single data format by validating the message with each data format and continuing with the (unique) format for which validation succeeds.

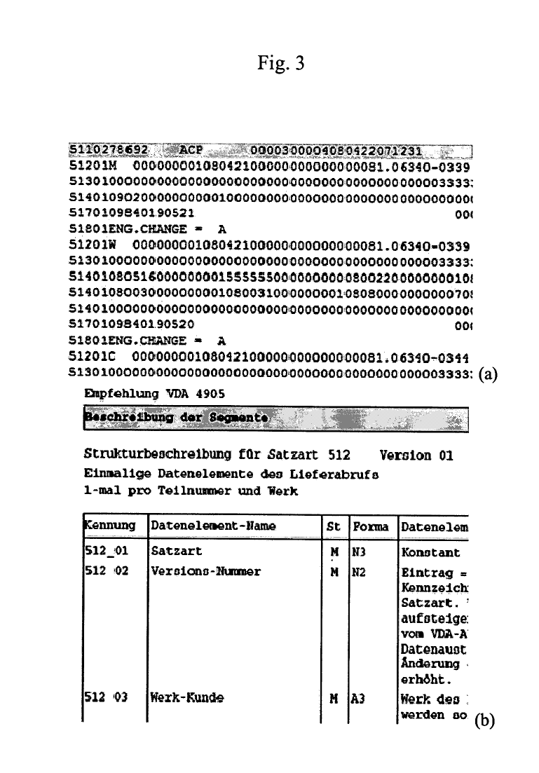

FIG. 3a shows an excerpt of a message processed by a method according to the invention.

FIG. 3b shows an excerpt of a rule set definition that is selected based on the determined format of the received message and may be used for validating the message. The arrows indicate correspondences between different parts of the message and the associated rules.

The rule definition may be kept in the system as a binary file, for rapid processing. If validation fails, the whole process may be cancelled by raising an exception.

In one embodiment of the invention, the message may be recognized in step 120 by a neural network. In a preferred embodiment, the neural network is a multi-layer perceptron. A multi-layer perceptron comprises, besides an input and an output layer, also further hidden layers that define an input-to-output mapping of the neural network.

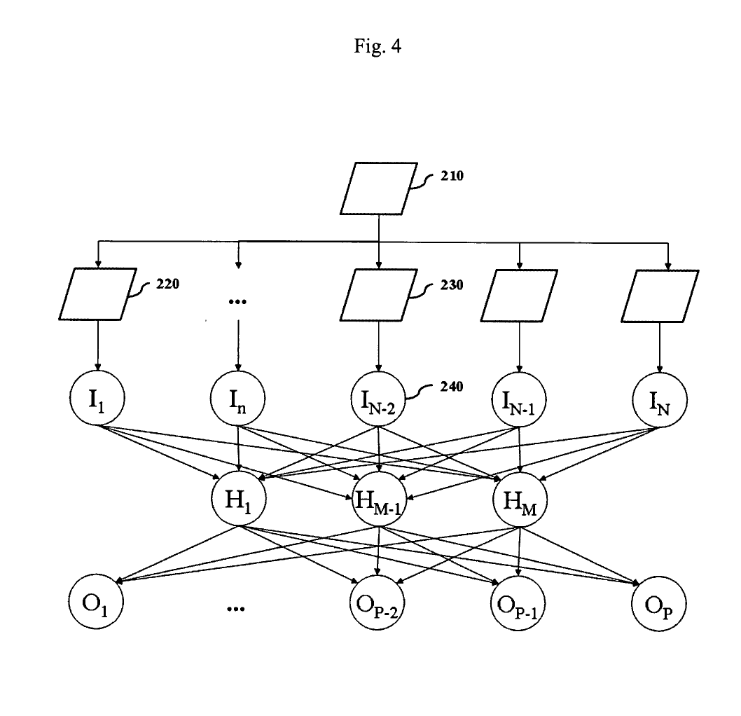

FIG. 4 shows a multilayer neural network used for determining a data format of a message according to an embodiment of the invention

The received message 310 is first processed to obtain inputs 320, 330 etc. for different input nodes of the multi layer neural network. In other words, a feature map may be applied to the electronic message in order to extract a feature vector whose components are indicative of the possible message format.

For example, the first input 320 to the neural network may be given by a proper subset of bits of the received electronic message. Preferably, the proper subset of bits is an initial sequence of bits of the electronic message, as EDI messages usually include identifying content at the beginning of the message. Moreover, input 330 may comprise the results of statistical evaluations of the electronic message, for example the number of brackets or colons used in the messages, which indicate different data formats (XML, EDI or others). The inputs obtained from processing the received electronic message or the feature vector components are then individually fed into the different input nodes I₁, . . . , I_{N} of the neural network. The neural network shown in FIG. 3 comprises a single hidden layer of so-called hidden neurons H₁, . . . , H_{M}. Each input neuron is mapped to each hidden neuron first. Then the output of each hidden neuron is mapped to each of the so-called output neurons O₁ to O_{P}.

In a particular embodiment, a perceptron may comprise an input and an output layer and two (2) layers of hidden neurons. Every layer may comprise 512 neurons. Every neuron of a particular layer is fully connected with every neuron of the next layer (feedforward network). Thus, this particular network has 786.000 nodes, each node having an individual weight. Hence, the neural network may address 512 different formats uniquely. In total, 2⁵¹² different formats may be addressed by a neural network

Likewise, 2⁵¹² different formats may be input into the neural network for recognition. In a basic embodiment, the first 512 bits of a message may be input into the system.

However, in a preferred embodiment of the invention, the entire content of the message may be subjected to a statistical evaluation. The result may be represented by a 240 bit value, input to the neural network. Also, 276 bits representing selected contents of the message, e.g. bits from different positions of the message, are input to the network. Thereby, 2²⁴⁰*2²⁷⁶ different input formats may be recognized. Structural criteria as well as the content of the message may be used for format recognition.

The network may be trained using a backpropagation method. Only the input message and the expected result are needed for this training. Tests of the inventors have shown that different formats may correctly be recognized after around 20 training cycles.

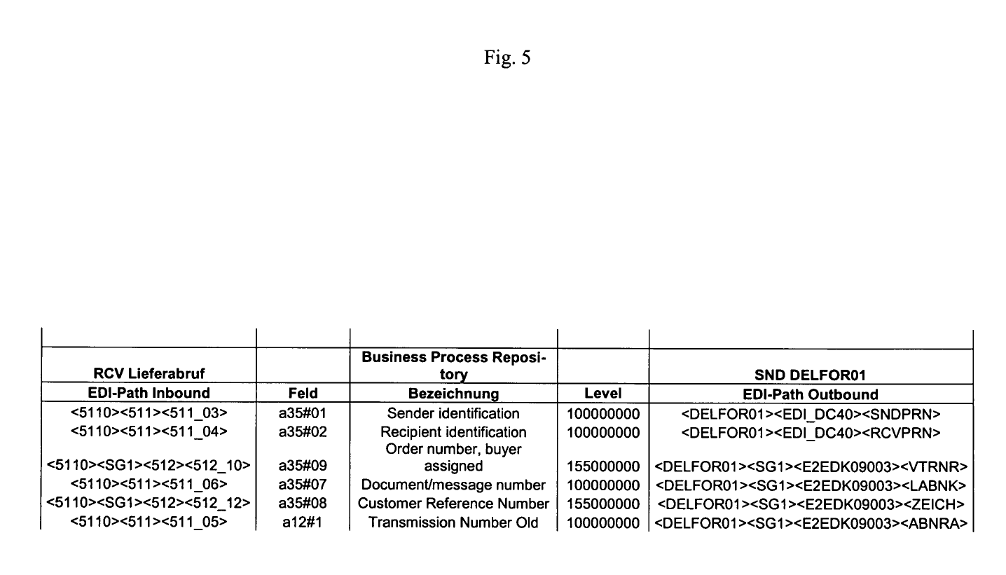

FIG. 5 shows an example of a table defining a set of mapping rules for mapping the contents of the incoming message to a different format In one embodiment of the invention, the contents may be associated with standardized fields in a central database and then written to the database, as specified by the rules.

More specifically, the first column of the table, termed “RCV Lieferabruf”, defines a source field of an incoming message by stating the EDI “as” of the field of the inbound message. More particularly, each row in the first column comprises a sequence of 3D distinct numerals delimited by angular brackets, wherein the first numeral, here <5110>, describes the type of the message. Second numeral in the sequence, e.g. <511>, describes the “Satzart” (record type). The third numeral in sequence, e.g. <511_{—}03>, designates the data element or field within the structure of the source message.

The second column, termed “business process repository”, comprising three sub-columns “Feld, Bezeichnung” and “Level” defines the target, to which the source information is to be mapped. More particularly, the column termed “Feld” defines for each field in the source message having a particular EDI-path described in a row of column 1 to which field in the target structure the information is to be mapped. E.g., the content of the field designated by the EDI-path <5110<<511><511_{—}03> is mapped to field “a35#01”. The second column, termed “Bezeichung” comprises a natural language description of the meaning of the field defined in the second sub-column. In other words, the business process depository defines at the same time a target format for matting from the data format of an incoming message and the semantics of the mat data element. The three sub-columns “Feld, Bezeichnung” and “Level” comprise therefore the meaning of the associated data element. The third sub-column defines a so-called “hierarchy level”, which is a further aspect of the target structure, not relevant to the invention.

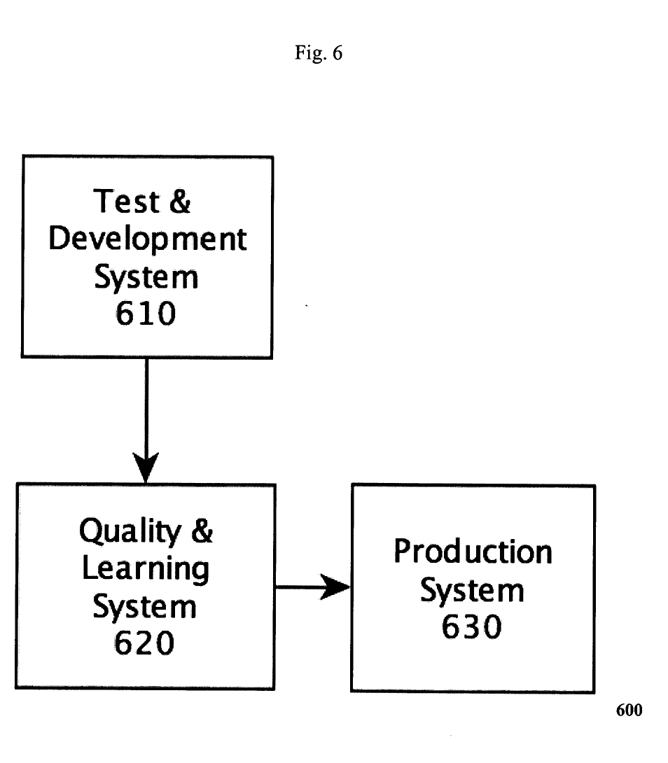

FIG. 6 shows an architecture 600 of an application system for converting messages according to an embodiment of the invention.

The architecture comprises three individual systems 610, 620 and 630. A test and development system 610 may be used for learning individual formats and associating them with a set of transformation rules. A quality and learning system 620 may be used for learning the format learned in the first system, in the context of all other already known formats.

Finally, a production system 630 may be used as an actual production system that inherits the knowledge derived in the second system 620.

In a further embodiment of the invention, the step of learning comprises a syntactic and semantic analysis of the incoming electronic message, for which no data format, partner profile or mapping has been found in the register.

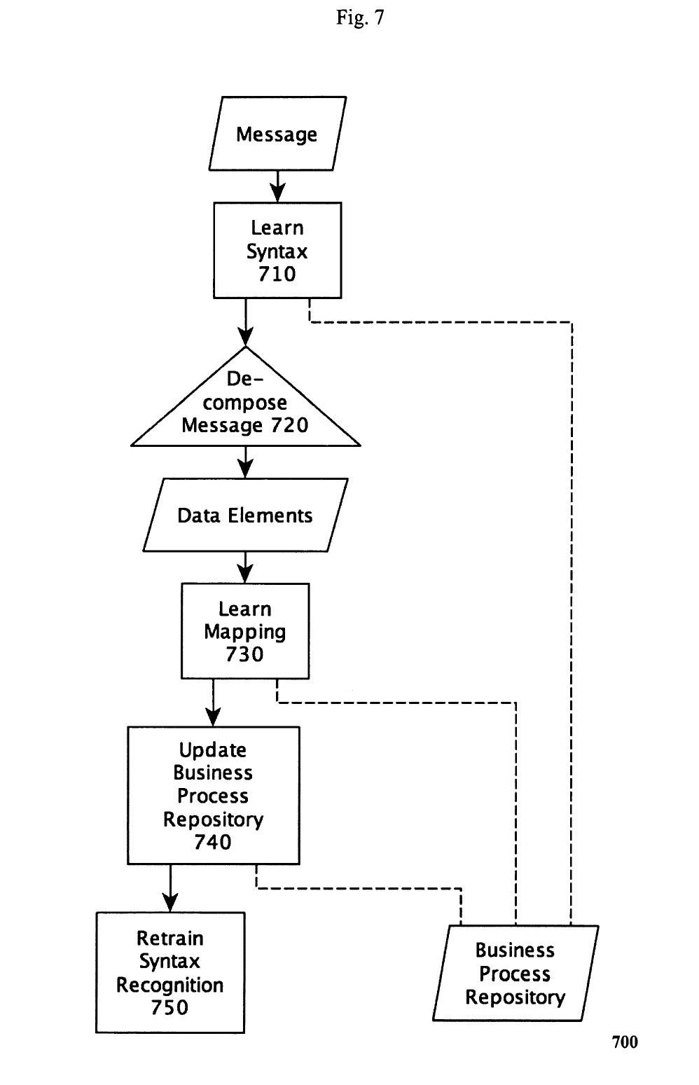

FIG. 7 shows a flowchart of a method for learning a new data format according to one embodiment of the invention.

In syntax learning step 710, According to one embodiment of the invention, a user interaction may be provided, in order to allow a user to identify the syntactic format manually, or to provide a new format.

In step 720, the message is decomposed into individual syntactic data elements, using the newly acquired syntax definition.

In step 730, a new mapping from the individual data elements to target elements is learned by determining the meaning or semantics of each individual data element. This may be achieved by matching each of the determined constituent syntactic data elements against a set of known possible semantic elements in order to determine a mapping for the data element.

More particularly, all data elements, or their syntax keys respectively, may be matched against an existing pool of data and be associated with unique semantic information, if possible, The matching may be effected by comparing the syntax keys of the message with syntax keys in an existing data pool, that are already associated with semantic information. If exactly one matching syntactic element exists in the data pool, semantic information may uniquely be assigned by expanding the syntax key of the message. Optionally, the syntax key may be associated with further qualifying elements, whose data contents may also be taken into account when assigning unique semantic information.

All remaining syntactic elements may be analyzed by determining their formal and contextual attributes. Contextual attributes may comprise message type, their level in the document hierarchy, the depth of the hierarchical nesting of the message, the country, the industry, etc. Formal attributes may comprise whether the element has numerical type, alphanumerical type, the number of decimals, whether it has fixed length, whether its positive, negative, whether it's a date, the format of date, leading zeroes, trailing zeroes, whether it matches a regular expression, whether it designates a numerical interval, whether it's an enumeration, etc. This may be achieved by a modular subsystem of the learning module.

An association of data elements with semantic elements may then be determined based on the assigned formal and contextual attributes. If a high degree of similarity may be determined based on these attributes, the association may be used as a fixed association in the business process repository for further use.

Alternatively, data elements may fed into a neural network for further assignment of semantic elements, in order to determine the message mapping definition.

Auxiliary, a user interaction may be provided in order to allow a user to determine a mapping rule for a given data element. Thereby, the user may be presented with a list of most likely mappings and prompted to select the right one or to provide a new mapping for the individual data element.

In step 740, the business process repository is updated with the new syntax definition, associated with a hash value of the analyzed message, the newly learned message mapping definition and validation rules.

In step 750, the syntax recognition procedures, e.g. a neural network, are retrained, taking the updated business repository into account.

In other words, the inventive method uses similarity in order to match an incoming message with data formats known from the repository. Data elements, data structures or parts of data structures that are not already known may be obtained from a user dialogue. All information obtained from interacting with the user enriches the repository and all automatic recognition modules/methods that depend on it.

After recognizing the syntax, each discrete data element is associated with semantic information, on which the matting between different data formats is based. Data elements, whose semantics may not be obtained from their syntactical category alone, may automatically be analyzed under formal and contextual aspects. The data elements thus analyzed are then compared to abstract data elements from the depository, based on semantic elements. Semantic elements are abstract descriptions of possible expressions of a data element, that are described by a unique name on the one hand and by a list of formal and contextual attributes on the other hand in the business depository. They may be defined at any time of the system's use.

Based on the assigned attributes, a similarity of the data elements and semantic elements may be accessed using statistical procedures. If a unique association may not be determined, a user may select the most probable assignment/matting to a designed target format, based on a list of possible assignments having high probability. Alternatively, the system may implement automatic procedures for selecting a computable matting, e.g. selecting the matting having the highest probability or based on additional tests.

### Summary/Application

Using the above-described method and system according to the invention allows processing input messages and data for which no converter profile exists in the database, if the system knows the pattern of the message or data. Therefore, copies of workflows are not needed in the inventive system.

If the inventive system is given data or messages whose format is not already known, then it is able to derive a most similar format.

If the inventive system has acquired a new format, it may automatically recognise and process it from this moment on.

1. Computer-implemented method for converting messages between different data formats in a network for electronic data interchange (EDI), comprising the steps:
receiving (110) an electronic message from a participant of the network;
determining (120) at least one first possible data format of the electronic message, based on the content of the electronic message;
validating (130) the electronic message, based on the at least one first possible data format; and
converting (140) the message from the first data format into a second predetermined data format, using a message mapping definition associated with the first data format, if the validating step succeeds; and
learning a new data format that validates the electronic message and an associated message mapping definition otherwise.

2. The method according to claim 1, wherein a plurality of first possible data formats is determined and each possible data format of the plurality is validated.

3. The method according to claim 1, wherein the at least one possible data format is determined from a machine-readable non-volatile memory comprising a multitude of possible data formats.

4. The method according to claim 1, wherein the data format is determined based on a proper subset of bits of the electronic message, having a predetermined size.

5. The method according to claim 4, wherein the proper subsets of bits is an initial bit sequence of the electronic message.

6. The method according to claim 1, wherein the data format is further determined based on statistical evaluations of the electronic message.

7. The method according to claim 1, wherein the first possible data format of the electronic message is determined using a neural network.

8. The method according to claim 1, further comprising the step of storing an association of the participant and the first data format in a machine-readable non-volatile memory for future reference, if the validating step succeeds.

9. The method according to claim 8, wherein the step of determining comprises the steps of:
checking, whether an association of the participant and an associated data format has already been stored in the machine-readable non-volatile memory; and
using the associated data format as the at least one possible data format of the electronic message, if yes.

10. The method according to claim 1, wherein the step of validating comprises the steps of:
automatically requesting the participant to confirm the first data format via an electronic communication channel;
validating the electronic message, if the first data format is confirmed by the participant.

11. The method according to claim 3, wherein the step of converting comprises the steps of:
retrieving a predetermined message mapping scheme associated with the first data format; and
applying the predetermined message mapping scheme to the electronic message in order to convert it into the second data format.

12. System for converting messages between different data formats in a network for electronic data interchange (EDI), comprising a back-end server and a front-end server, the front-end server comprising:
means for receiving an electronic message from a participant of the network;
means for determining at least one first possible data format of the electronic message;
means for validating the electronic message, based on the at least one first possible data format; and
means for converting the message from the first data format into a second predetermined data format, if the validating step succeeds.
